(19) United States
(12) Patent Application Publication
(10) Pub. No.: US 2002/0098754 A1
(43) Pub. Date: Jul. 25, 2002

(54) Calcium carbonate filled epoxy urethane string binders

(76) Inventors: Martin C. Flautt, Granville, OH (US); Leonard J. Adzima, Pickerington, OH (US); James R. Priest JR., Nashport, OH (US)

Correspondence Address: OWENS CORNING, 2790 COLUMBUS ROAD, GRANVILLE, OH, 43023, US

(21) Appl. No.: 09/943,607

(22) Filed: Aug. 30, 2001

Related U.S. Application Data
(63) Continuation-in-part of application No. 09/721,355, filed on Nov. 22, 2000.

(51) Int. Cl. B32B 3/00; D02G 3/00

(52) U.S. Cl. 442/59; 428/375

(57) ABSTRACT

A string binder is disclosed which is useful for making reinforcing articles for use in the manufacture of molded composite articles. The string binder comprises a fibrous substrate with a chemical treatment, applied thereto, comprising an epoxy, a polyurethane, at least one curing agent, a thickener, and a filler. Additionally, the string binder may be co-roved with one or more ends of a separate fibrous pre-form material to make a product suitable for use in various molding application. The filler, preferably a calcium carbonate filler, of the present invention improves surface characteristics of the finished reinforcing articles by minimizing or eliminating surface fiber prominence and blistering. The string binder made with fillers additionally reduces manufacturing costs and raw material costs as compared with string binders made without such fillers.

### CROSS-REFERENCE TO RELATED APPLICATIONS

The present application is a continuation in part of application Ser. No. 09/721,355, filed Nov. 22, 2000.

### TECHNICAL FIELD AND INDUSTRIAL APPLICABILITY OF THE INVENTION

The present invention relates generally to chemically treated reinforcing fibers, pre-forms made with the same, and polymer composites made with the same. More particularly, this invention relates to: reinforcing fibers having a chemical treatment comprising an epoxy, a polyurethane, at least one curing agent, a thickener, and a calcium carbonate filler; pre-forms made with such fibers; and polymer composites made with such pre-forms.

### BACKGROUND OF THE INVENTION

Fibers, such as glass fibers, are commonly used as reinforcements for synthetic polymer composites. These fiber reinforced composites are desirable for their combination of light weight and strength and are useful in a variety of applications including automobile components and housings for computers.

Conventional techniques may be used to make fiber reinforced composites and usually involve placing a pre-form in a mold and forming a polymer matrix around the pre-form. Methods for making pre-forms involve depositing chopped reinforcing fibers on to a porous form, consolidating the fibers by heating, and cooling to form a mat structure. For adequate consolidation and pre-form strength, a resin binder is usually incorporated before the heating step so that when heated, the resin flows across the fibers and acts as a binder. When the resin binder is a thermoset, a thermoset resin is incorporated before the heating step so that when heated, the thermoset resin flows across the fibers and acts as a thermoset binder when cured. The incorporation of a resin binder in order to economically produce adequate pre-forms continues to be a significant problem in the art.

One method of resin binder incorporation is known as the “wet laid” process involving the formation of an aqueous mixture of chopped glass fibers and resin binder, usually under agitation in a mixing tank. The resulting mixture may then be poured onto a porous mold or screen where suction is applied to remove liquid content. Another wet laid process involves depositing chopped fibers on a mold, spraying the fibers with an aqueous composition containing the resin binder. Alternatively, the chopped fiber can be sprayed with the aqueous composition while they are being chopped and deposited on the mold. The final step in all these processes is to heat the fibers on the mold causing the resin binder to flow and set. Unfortunately, due to the nature of glass fibers, it is difficult to obtain a uniform dispersion of fibers in a wet laid process. Poor fiber dispersion leads to undesirable qualities in a resultant pre-form such as poor structural strength. Additionally, a wet laid process often involves the use of volatile organic compounds (VOCs) and other organic solvents thereby triggering environmental safety concerns regarding their use.

In contrast to wet laid processes are “dry processes” where a resin binder is dry mixed with chopped fibers, heated to melt and cure the resin, and cooled to form a pre-form. Alternatively, a resin binder may be sprayed in molten form on to chopped fibers and cooled to form a pre-form. Unfortunately, an application of large quantities of resin binder is required in order to produce an acceptable pre-form. As a result, there is an undesirable generation of excess molten resin which may foul equipment and require extensive cleanup operations. Furthermore, when combined with a polymer matrix to form a reinforced composite, large quantities of resin binder present in a pre-form exacerbates any incompatibility between the resin binder and polymer matrix. Accordingly, there may be an increased likelihood of defects in the reinforced composite such as: 1) blistering, the result of undesirable chemical reactions between the resin binder and polymer matrix; 2) reduced bond strength between the pre-form and polymer matrix, also the result of undesirable chemical reactions; and 3) bleeding, the result of resin binder diffusing through the polymer matrix.

One solution to the problems caused by the aforementioned wet and dry processes is the production of string binders as disclosed in U.S. patent application Ser. No. 09/280,808, filed Mar. 30, 1999, entitled “String Binders” and U.S. patent application Ser. No. 09/593550 filed Jun. 14, 2000, entitled “String Binders and Method for Making Same.” These references generally disclose a string binder made by incorporating molten thermoset resin on a strand composed of gathered fibers and cooling. These resin incorporated strands may then be chopped, directed to a mold, heated to cause the resin to flow, and cooled. When cooled, a preform with a partially cured resin binder is formed. The preform may then be further processed into a composite part.

Despite the advantages string binders provide in eliminating many of the cumbersome steps of conventional processes, the current methods for producing string binders require the handling of molten thermoset resins.

One solution to this problem is disclosed in U.S. Ser. No. 09/751,355, filed Nov. 22, 2000, entitled “Epoxy Urethane String Binders” which is herein incorporated by reference. This reference discloses a string binder comprising a fibrous substrate having a chemical treatment. The fibrous substrate preferably comprises glass filaments that are gathered into strands. The chemical treatment is applied to the fibrous substrate in aqueous form and comprises an emulsified epoxy resin, an polyurethane dispersion, at least one curing agent, a thickener, and water. The chemical treatment may be applied by immersing the fibrous substrate in a bath comprising the chemical treatment. The chemically treated fibrous substrate may then be dried and wound on a winder. Chemically treated fibrous substrates made in such a manner belong to a general class referred herein as “string binders.” The term “string binder” generally refers to fibrous substrates that incorporates a resin binder. The string binders are then made into a pre-form by chopping the string binder, directing the choppings on to a mold, and heating to cause the chemical treatment applied to the string binder to melt, flow and cure into a thermoset resin binder. Alternatively, the pre-form may be made by weaving a plurality of string binder strands. A reinforced composite may then be made by placing the pre-form in a mold, injecting a polymer matrix resin, and forming the polymer matrix around the mat. The polymer matrix is preferably formed by reaction injection molding.

One problem with composite materials made according to this process is defects along the surface of the formed composite articles. Specifically, fiber prominence is noted along the surface of the finished composite articles. Further, blisters may form on the surface of the finished composite article that are the result of undesirable reactions between the resin binder and polymer matrix.

Another problem with the current method is that the chemical treatment added to the string binder increases the tension, or drag, of the roving as it runs through the bath. This reduces the efficiency of the coating process and may damage the string binder.

### SUMMARY OF THE INVENTION

One object of the invention is to improve the surface characteristics of the composite part by minimizing fiber prominence and blisters on the surface of the molded composite part.

Another object of the present invention is to reduce the drag on the roving as the chemical treatment is applied.

The above objects are accomplished by introducing filler to the chemical treatment used to form the string binders. The filler, preferably calcium carbonate, minimizes fiber prominence and blistering on the surface of the molded composite part. The filler also reduces drag on the roving as it passes through the chemical treatment bath. As the raw material costs of filler are typically cheaper than the resins and curing agents found in the chemical treatment, a cost savings is realized as an additional benefit.

Other objects and advantages of the present invention will become apparent upon considering the following detailed description and appended claims, and upon reference to the accompanying drawings.

### BRIEF DESCRIPTION OF THE DRAWING

FIG. 1 is a schematic diagram for making the calcium carbonate filled epoxy string binder according to one preferred embodiment of the present invention.

### DETAILED DESCRIPTION OF THE INVENTION

The present invention provides for a string binder having a filler, preferably a calcium carbonate filler, that may be used in continuous or chopped form as a raw material in preparation of pre-forms. Such pre-forms impart desirable physical characteristics to a reinforced composite comprising a polymer matrix and the pre-forms. The pre-forms may be placed in a mold where a polymer matrix is formed around the mat to produce a reinforced composite.

Fibrous Substrate

The string binders of the present invention comprise a fibrous substrate. Any suitable fibrous substrate may be used in the invention. Preferably, the fibrous substrate may be selected from fibrous materials that are commonly known in the art, such as glass, carbon, natural fibers, polymers and other fiberizable materials known in the art, or mixtures thereof. Examples of fibrous substrates that may be used either alone or in combination with glass or carbon fibers include thermoplastics including polyesters such as DACRON®, polyaramids such as KEVLAR® and natural fibers. The fibrous substrate is preferably a fibrous material in the form of continuous strands composed of multiple filaments. The strands may take the form of yarns, or rovings. Preferably, the strands of fibrous substrate comprise reinforcing fibers. Typically, such strands are formed by combining filaments of the reinforcing fibers as they are attenuated from a fiber-forming apparatus such as a bushing or orifice plate, although they may also be made by any method conventionally known in the art. The filaments may be coated with a suitable sizing composition. For example, a suitable sizing composition may comprise functional agents such as lubricants, coupling agents and film-forming polymers. After being coated with the sizing composition, the filaments may be gathered into strands. These strands may then be formed into yams or rovings. Preferably, the filaments making up the strands are glass and have a diameter preferably ranging from 3.5 to 24 μm and more preferably from 9 to 13 μm. The preferred filament diameters correspond to U.S. filament designations G, H, and K. In the method according to the invention, preferably the strand input has a yield of from 3,700 to 7,500 yd/lb., most preferably 7,500 yd/lb., or approximately 66 TEX (g/km a measurement reflecting the weight and thickness of the strand).

Chemical Treatment

The chemical treatment of the present invention comprises an emulsified epoxy resin, a polyurethane dispersion, at least one curing agent, a thickener, a filler, and water.

The chemical treatment preferably comprises the emulsified epoxy resin in an amount of approximately 20 to 70 wt. % of the total chemical treatment weight. Preferably, this weight percent is between 20 and 40%. The emulsified epoxy resin is preferably Epirez 3546 available from Shell Chemical Company.

The chemical treatment preferably comprises the polyurethane dispersion in an amount of approximately 5 to 40 weight percent of the total chemical treatment weight, Preferably, this weight percent is between 5 and 20%. The polyurethane is preferably chosen from a group consisting of Aquathane D516, available from Reichhold Chemical Company, and Witcobond W290H, available from Witco Chemical Company. The polyurethane is most preferably Witcobond W290H available from Witco Chemical Company.

The chemical treatment preferably comprises two curing agents. One of the curing agents preferably is a mixed aromatic amine such as Epicure 3253 available from Shell Chemical Company. The chemical treatment preferably comprises the mixed aromatic amine in an amount of approximately 0.03 to 0.23 wt. % of the total chemical treatment weight. Preferably, this weight percent is between 0.05 to 0.08%. The other curing agent is preferably a cyanoguanidine such as Amicure CG 1400 available from Air Products and Chemicals Inc. The chemical treatment preferably comprises the cyanoguanidine in an amount of 0.35 to 1.51 wt. % of the total chemical treatment weight. Preferably, this weight percent is between 0.40 and 0.58%.

The chemical treatment preferably comprises a thickener in sufficient amounts to adjust the viscosity of the chemical treatment in the range of between 1000 to 2500 cps. The viscosity of the chemical treatment is measured by a Brookfield LVF Viscometer (available from Brookfield Company) using spindle number 3 at 300 rpm. The thickener is preferably a water soluble polymer, most preferably an arcrylamide polymer with sodium acrylate. The chemical treatment preferably comprises an acrylamide polymer in an amount of approximately 0.05 to 0.50 wt. %, more preferably 0.10 to 0.25 wt. %, and most preferably from 0.10 to 0.15 wt. %. The acrylamide polymer is preferably Drewfloc 270 available from the Drew Industrial Division of Ashland Chemical Company.

The chemical treatment preferably comprises a filler in sufficient amounts to improve the surface characteristics of molded composite parts. The filler also reduces viscosity of the chemical treatment bath and reduces drag associated with the impregnating process. The chemical treatment comprises the filler in an amount of approximately 10 to 40 weight % of the total chemical treatment weight. Preferably, this weight percent is between 15 and 25%. The filler is preferably a calcium carbonate filler such as Cal-White II available from Georgia Marble having a diameter size between 5 and 7 microns. While calcium carbonate is a preferred filler, other fillers that are known in the art are contemplated to be used in conjunction with or in place of calcium carbonate, including silicon dioxide and aluminum trihydrate.

Optional Ingredients

The chemical treatment may include optional ingredients which serve to impart desired properties to a fiber reinforced composites. For example, the chemical treatment may further comprise flame retardant and/or pigments.

Chemical Treatment Application

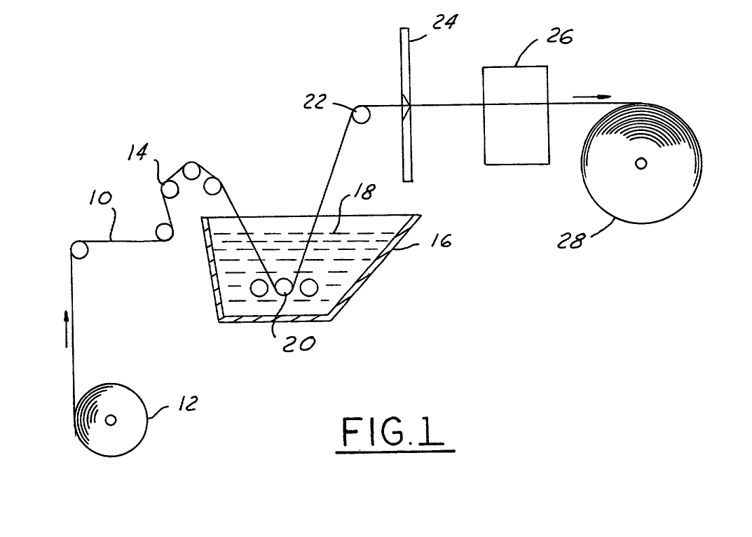

The chemical treatment of this invention may be applied to a fibrous substrate by any means known in the art. A preferred method is illustrated by FIG. 1 where a strand 10 of a fibrous substrate, preferably an E-glass, is fed from a feed spool 12 through an optional tensioner bar arrangement 14. The strand 10 may be passed through a bath 16 holding the chemical treatment 18 of this invention. The bath 16 is preferably equipped with conventional breaker bars 20 to guide the strand input 10 while it is submerged in the chemical treatment 18 which is preferably at room temperature (60-80° F. or 15-26° C.). After exiting the bath 16, the strand 10 may be passed over at least one additional breaker 22 before being fed through a stripper die 24, or alternatively a squeegee, to remove substantially all but the desired amount of treatment from the strand. The stripper die 24 is selected to have an orifice opening of the appropriate diameter to meter the desired amount of resin onto the fibrous substrate. The strand 10 may then be passed through an oven 26 for drying. After exiting the oven 26 the strand 10 is allowed to cool. The strand 10 is then wound onto a product spool or collet 28 using any conventional winding apparatus. The rate at which the strand is wound depends upon the drying conditions, the composition of chemical treatment, and the amount of chemical treatment remaining on the strand 10 once the excess has been removed. In short, the winding rate is preferably the maximum rate possible that allows the chemical treatment to dry on the strand 10 before it is spooled, and is readily determined to an person ordinarily skilled in the art. Rates on the order of 80-1100 ft/min (24-422 m/min) have been achieved.

In the present invention, the filler aids in reducing tension as the strand 10 is passed through the bath 18 and over the breaker bar 22. It is believed that the filler reduces the drag by lowering the coefficient of friction of the strand across the breaker bar 22. In effect, the filler acts similarly to ball bearings, aiding the strand in moving across the breaker bar 22. In the present invention, softer fillers such as calcium carbonate are preferable, as these fillers are less likely to break the strand as it moves across the breaker bar.

Co-Roving

Fibrous substrates which are chemically treated in accordance with this invention (“string binders”) may by themselves be used to make a pre-form or they may be co-roved with a reinforcing fiber material to form a multi-end roving product which in turn may be used to make a pre-form. This reinforcing fiber material may be selected from glass, polymer, natural fibers, or any combination thereof. Examples of such reinforcing fiber materials include, but are not limited to glass, KEVLAR, polyaramids, polyesters such as DACRON, and natural fibers such as linen, jute, hemp, cotton and sisal. Preferably, the reinforcing fiber material is in the form of a continuous roving. To form the co-roved multi-end product, one or more ends of string binder are roved together with one or more ends of a reinforcing fiber material, such as glass, using any conventional winding process. For example, roving ends from 1-3 wound spools of continuously formed string binder of the present invention may be lined up in a creel simultaneously with roving ends from 10-20 forming cakes of glass reinforcing fiber strand. Unlike the string binder of the present invention, the reinforcing fiber material used to make the co-roved product is not treated with the chemical treatment used to form the string binder. This reinforcing fiber material may, however, be sized with an acceptable sizing treatment before being co-roved with the string binder. Application of a sizing treatment typically provides certain desirable effects to the reinforcing fiber material, such as protection from damage by attrition or erosion, and enhances wetout of the fibers in the composite matrix, when molded. Preferably, the sizing treatment is applied to the strands of reinforcing fiber material before they are wound into forming cakes.

The combined ends of the string binder and reinforcing fiber material may then be co-roved or wound together onto a spool, thereby forming a multi-end roving having a proportionate amount of string binder within the roving. The proportion of string binder to the reinforcing fiber material may be varied according to the desired product specifications, the quantities of each being readily determined by one having ordinary skill in the art. Preferably, the proportion of string binder to reinforcing fiber material in the present invention ranges from 5 to 30% (more preferably 10 to 20%) by weight of string binder to 80% to 90% by weight of reinforcing fiber material.

Pre-form

The string binder of the present invention and multi-end roving formed therefrom may be incorporated into several reinforcing articles, depending on the desired application. For example, the multi-end rovings may be used to form a woven fabric reinforcement, such as a woven roving or a multi-axial stitched reinforcement. Alternatively, the string binder and multi-end rovings formed therefrom may also be used, in continuous or chopped form, in various applications requiring an input of reinforcing fiber segments.

In an embodiment requiring input of chopped reinforcing fiber segments, the string binder, or, preferably, the multi-end roving comprising the string binder, may immediately be chopped into segments instead of being spooled after forming. Preferably, the length of such segments is typically from ½ inch (1.27 cm) up to 3 inches (7.62 cm) in length. Most preferably, the chopped segments are from 1 inch (2.54 cm) to 3 inches (7.62 cm) in length.

The segments obtained according to the aforementioned procedure are preferably used to make pre-forms using a spray-up process. Such a process is described in U.S. Pat. No. 3,170,197, which is herein fully incorporated by reference for U.S. patent practice. In a particularly preferred embodiment including this method, segments of a multi-end roving comprising the string binder are blown or spread by conventional means over a shaped pre-form screen and a sufficient level of heat applied to melt and flow the chemical treatment enough to permit some fusing of the segments and partial curing of the urethane epoxy resin. Preferably, suction is applied to promote compacting of the segments as they fuse. The process of fusing allows the layered material to conform to the shape of the pre-form screen, and the material is then set into a solid matted structure or pre-form that may be physically transported if necessary to another location to complete the molding process that forms the final composite product.

Where the reinforcing article is a pre-form, it may typically comprise from 10% to 20% by weight of the string binder, in combination with from 80% to 90% by weight of another pre-form material. The weight ratio of the amount of fibrous carrier substrate to the amount of dried chemical treatment in the string binder preferably ranges from 99:1 to 85:15 with 94:6 most preferred. To make the pre-form, the chopped segments may be laid up on a consolidation screen, and optionally compressed using suction drawn through the screen to form the material into a desired shape that conforms to the contour of the screen. Consolidation may also be accomplished by placing a second screen on top of the pre-form prior to heating.

Reinforced Composite

The pre-form of this invention may be used in otherwise conventional molding processes to make a reinforced composite comprising the pre-form and a polymer matrix. Typically, the pre-form is placed in a mold cavity into which a moldable polymer matrix material is injected or otherwise added. Any moldable polymer matrix material that is compatible with the thermoset polymer material of the string binder in the pre-form may be used. Typical moldable polymer matrix resins that may be used include vinyl esters, polyesters, urethanes and phenolic thermoplastics. Preferably, the moldable polymer matrix is a urethane polymer that is compatible with the thermoset polymer material that is present in the string binder. For example the pre-form may be placed in a mold in which a isocyanate and a polyol may be injected to react and form a urethane polymer reinforced by the pre-form. The skilled artisan will be able to identify other moldable matrix resin materials suitable for use with pre-forms made according to this invention without undue experimentation.

### EXAMPLES

It will be appreciated by those skilled in the art that changes could be made to the embodiments described above without departing from the broad inventive concept thereof. It is understood, therefore, that the invention is not limited to the particular embodiments disclosed, but it is intended to cover modifications and equivalents which are within the spirt and scope of the invention, as defined by the appended claims.

A chemical treatment was made by mixing the ingredients as listed in Table A below. This chemical treatment was then applied to a glass fibers in accordance with the invention. The chemically treated fibers were then chopped and then manufactured into a preform in accordance with the invention. The preform was then used to make a reinforced composite in accordance with the invention. The performance of preforms made from the formulations listed in Table A are evaluated below in Table B. Thus, for example, panels A-1, A-2 and A-3 listed in Table B have fibers treated with from the chemical treatment having various curing times listed in column A of Table A, while panels D-1, D-2, and D-3 listed in Table B have fibers treated with from the chemical treatment having various curing times listed in column D of Table A.

TABLE A
EP/PU Ratio - 73/27 Based On As Received Materials

| | A | B | C | D | E | F |
|---|---|---|---|---|---|---|
| Epi-Rez | 50.56 | 50.56 | 50.56 | 30.30 | 26.00 | 20.79 |
| 3546 | | | | | | |
| Witcobond | 18.70 | 18.70 | 18.70 | 11.22 | 9.62 | 7.69 |
| W290H | | | | | | |
| Amicure | 0.97 | 0.97 | 0.97 | 0.58 | 0.50 | 0.40 |
| CG1400 | | | | | | |
| Epicure | 0.13 | 0.07 | | 0.08 | 0.07 | 0.05 |
| 3253 | | | | | | |
| Cal-White II | | | | 16.00 | 20.00 | 24.00 |
| Drewfloc | 10.00 | 10.00 | 10.00 | 10.00 | 10.00 | 10.00 |
| 270 (1.0) | | | | | | |
| Deionized | 19.64 | 19.70 | 19.77 | 31.82 | 33.81 | 37.07 |
| H₂O | | | | | | |
| TOTAL | 100.00 | 100.00 | 100.00 | 100.00 | 100.00 | 100.00 |
| Mix Solids, | 36.09 | 36.01 | 35.21 | 37.67 | 38.72 | 39.05 |
| % Wt. | | | | | | |
| Viscosity, | 1400 | 1620 | 1880 | 1280 | 1400 | 1560 |
| cps 6 | | | | | | |
| Viscosity, | 1000 | 1130 | 1220 | 900 | 940 | 1060 |
| cps 12 | | | | | | |
| Viscosity, | 608 | 672 | 740 | 532 | 528 | 612 |
| cps 30 | | | | | | |
| Viscosity, | 428 | 498 | 540 | 352 | 346 | 426 |
| cps 60 | | | | | | |
| FILM | Medium | Light | White | Light | Light | Light |
| COLOR | Yellow | Yellow | | Yellow | Yellow | Yellow |

TABLE B
PREFORM & PANEL PROPERTIES

| | | | | | | | Panel | | | |
|---|---|---|---|---|---|---|---|---|---|---|
| Treatment | Cure | Preform | Preform | Tensile | Tensile | Tensile | Surface | Panel | Panel | |
| Bath And | Time | Thickness | Weight | RT | 140 F. | 180 F. | Fiber | Surface | Surface | Panel Surface |
| Panel No. | Min. | In. | Grams | LBS. | LBS. | LBS. | Prominence | Blisters | Bleeding | Quality |
| A-1 | 3 | 0.229 | 28.18 | 353.6 | 242.4 | 111.1 | YES | NO | NO | GOOD |
| | | | | (69.7) | (35.6) | (27.9) | | | | |
| A-2 | 5 | 0.236 | 27.55 | 305.3 | 184.6 | 89.7 | YES | NO | NO | GOOD |
| | | | | (35.8) | (61.8) | (20.3) | | | | |
| A-3 | 7 | 0.222 | 28.26 | 329.4 | 220.2 | 115.6 | YES | NO | NO | GOOD |
| | | | | (18.5) | (59.5) | (22.4) | | | | |
| B-1 | 3 | 0.243 | 27.88 | 358.2 | 242.3 | 115.6 | YES | NO | NO | GOOD |
| | | | | (37.3) | (23.2) | (29.9) | | | | |
| B-2 | 5 | 0.222 | 28.85 | 398.9 | 269.7 | 137.5 | YES | NO | NO | GOOD |
| | | | | (43.2) | (43.8) | (22.6) | | | | |
| B-3 | 7 | 0.224 | 28.34 | 357.5 | 215.8 | 84.2 | YES | NO | NO | GOOD |
| | | | | (27.7) | (19.3) | (10.2) | | | | |
| C-1 | 3 | 0.249 | 27.46 | 282.9 | 163.2 | 81.5 | YES | NO | NO | GOOD |
| | | | | (52.4) | (20.5) | (8.3) | | | | |
| C-2 | 5 | 0.237 | 28.13 | 308.8 | 199.1 | 92.9 | YES | NO | NO | GOOD |
| | | | | (18.1) | (55.7) | (18.3) | | | | |
| C-3 | 7 | 0.229 | 27.73 | 305.4 | 152 | 91.3 | YES | NO | NO | GOOD |
| | | | | (43.5) | (28.7) | (22.1) | | | | |
| D-1 | 3 | 0.261 | 27.33 | 179.5 | 94.5 | 44.1 | NO | NO | NO | EXCELLENT |
| | | | | (30.8) | (13.9) | (9.3) | | | | |
| D-2 | 5 | 0.241 | 27.88 | 205.0 | 148.0 | 73.7 | NO | NO | NO | EXCELLENT |
| | | | | (37.9) | (29.3) | (25.4) | | | | |
| D-3 | 7 | 0.24 | 26.90 | 180.9 | 103.9 | 52.8 | NO | NO | NO | EXCELLENT |
| | | | | (?) | (34.6) | (19.5) | | | | |
| E-1 | 3 | 0.246 | 27.72 | 205.1 | 86.7 | 75.1 | NO | NO | NO | EXCELLENT |
| | | | | (44.4) | (30.2) | (15.5) | | | | |
| E-2 | 5 | 0.250 | 27.13 | 131.8 | 78.7 | 49.6 | NO | NO | NO | EXCELLENT |
| | | | | (17.3) | (30.2) | (8.1) | | | | |
| E-3 | 7 | 0.243 | 27.11 | 123.6 | 83.8 | 51.3 | NO | NO | NO | EXCELLENT |
| | | | | (20.8) | (35.1) | (11.6) | | | | |
| F-1 | 3 | 0.28 8 | 28.46 | 66.7 | 32.8 | 15.6 | NO | NO | NO | EXCELLENT |
| | | | | (22.9) | (7.2) | (6.7) | | | | |
| F-2 | 5 | 0.264 | 28.64 | 102.3 | 60.4 | 26.5 | NO | NO | NO | EXCELLENT |
| | | | | (10.8) | (13.9) | (6.4) | | | | |
| F-3 | 7 | 0.255 | 28.81 | 92.1 | 57.0 | 39.4 | NO | NO | NO | EXCELLENT |
| | | | | (25.1) | (24.0) | (7.1) | | | | |

As seen in Table B, preforms made with without Calwhite II filler (panels A-1 through A-3, B-1 through B-3, C-1 through C-3) showed fiber prominence, regardless of the cure time. Additionally, these panels were evaluated to have good panel surface quality. However, panels having between 16 and 24% by weight Calwhite II filler (panels D-1 through D-3, E-1 through E-3, F-1 through F-3) exhibited no fiber prominence and had excellent surface quality.

While the invention has been described in terms of preferred embodiments, it will be understood, of course, that the invention is not limited thereto since modifications may be made by those skilled in the art, particularly in light of the foregoing teachings.

What is claimed is:

1. A reinforcing fiber having an applied chemical treatment, wherein said applied chemical treatment is applied as an aqueous treatment comprising an emulsified epoxy resin, a polyurethane dispersion, at least one curing agent, a thickener, water, and a filler.

2. The product of claim 1 wherein said applied chemical treatment is dried.

3. The product of claim 1 wherein said thickener comprises a water soluble polymer.

4. The product of claim 1 wherein said thickener comprises an acrylamide polymer.

5. The product of claim 1 wherein said thickener comprises Drewfloc 270.

6. The product of claim 1 wherein said emulsified epoxy resin comprises Epirez 3456.

7. The product of claim 1 wherein said polyurethane dispersion comprises Witcobond W290H dispersed in water.

8. The product of claim 1 wherein the applied chemical treatment comprises a mixed aromatic amine curing agent and a cyanoguanidine curing agent.

9. The product of claim 8 wherein said mixed aromatic amine curing agent comprises Epicure 3253 and said cyanoguanidine curing agent comprises Amicure CG 1400.

10. The product of claim 1 wherein said filler is selected from the group consisting of a calcium carbonate filler, a silicon dioxide filler, and an aluminum trihydrate filler.

11. The product of claim 2 wherein the reinforcing fiber forms a strand having said applied chemical treatment.

12. A reinforcing fiber mat comprising a plurality of said reinforcing fibers of claim 11.

13. A composite comprising a polymer matrix and said reinforcing fiber mat of claim 12.

14. The product of claim 1 wherein said filler comprises a calcium carbonate filler.

15. The product of claim 14 wherein said calcium carbonate filler comprises Georgia Marble Calwhite II.

16. The product of claim 1 wherein said filler comprises between approximately 10 and 40% by weight of said applied chemical treatment.

17. The product of claim 1 wherein said filler comprises between approximately 15 and 25% by weight of said applied chemical treatment.

18. A method for reducing surface fiber prominence in a reinforced composite part made from an epoxy urethane string binder, the method comprising the step of introducing a filler in a first amount to an aqueous chemical treatment bath, wherein said aqueous chemical treatment bath is used to apply a chemical treatment to a fibrous substrate that forms the epoxy urethane string binder.

19. The method of claim 18, wherein said first amount of said filler is between approximately 10 and 40 percent of the weight of said chemical treatment bath.

20. The method of claim 18, wherein said first amount of said filler is between approximately 15 and 25 percent of the weight of said chemical treatment bath.

21. The method of claim 18, wherein said filler is a calcium carbonate filler.
